(19) United States
(12) Patent Application Publication
(10) Pub. No.: US 2010/0147667 A1
(43) Pub. Date: Jun. 17, 2010

(54) KEYPAD ASSEMBLY

(75) Inventor: Chao-Yuan Cheng, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FIH (HONG KONG) LIMITED, Kowloon (HK)

(21) Appl. No.: 12/393,148

(22) Filed: Feb. 26, 2009

(30) Foreign Application Priority Data
Dec. 11, 2008 (CN) 200810306182.X

(51) Int. Cl. H01H 13/76

(52) U.S. Cl. 200/5 A

(57) ABSTRACT

A keypad assembly used in a portable electronic device is described. The keypad assembly includes a shelf, a keypad mounted to the shelf, and at least one light-emitting source. The keypad is made of a light-guiding material. The light-emitting source faces the keypad and is adjacent to the keypad.

### BACKGROUND

1. Field of the Disclosure

The disclosure relates to keypad assemblies and, particularly, to an illuminated keypad assembly used in a portable electronic device.

2. Description of Related Art

With development of technology, portable electronic devices (e.g., mobile phones or personal digital handsets) are made available with ever-greater number of user-friendly functions, e.g., illuminated keypads etc.

A typical illuminated keypad transmits light using a light-guiding board. Thus, the keypad assembly can have a complex structure.

Therefore, there is room for improvement within the art.

### BRIEF DESCRIPTION OF THE DRAWINGS

Many aspects of the keypad assembly can be better understood with reference to the following drawings. These drawings are not necessarily drawn to scale, the emphasis instead being placed upon clearly illustrating the principles of the present keypad assembly. Moreover, in the drawings like reference numerals designate corresponding members throughout the several views.

FIG. 1 is an exploded, isometric view of a keypad assembly, in accordance with an exemplary embodiment.

FIG. 2 is a cross-sectional view of the keypad assembly shown in FIG. 1.

### DETAILED DESCRIPTION OF EXEMPLARY EMBODIMENT

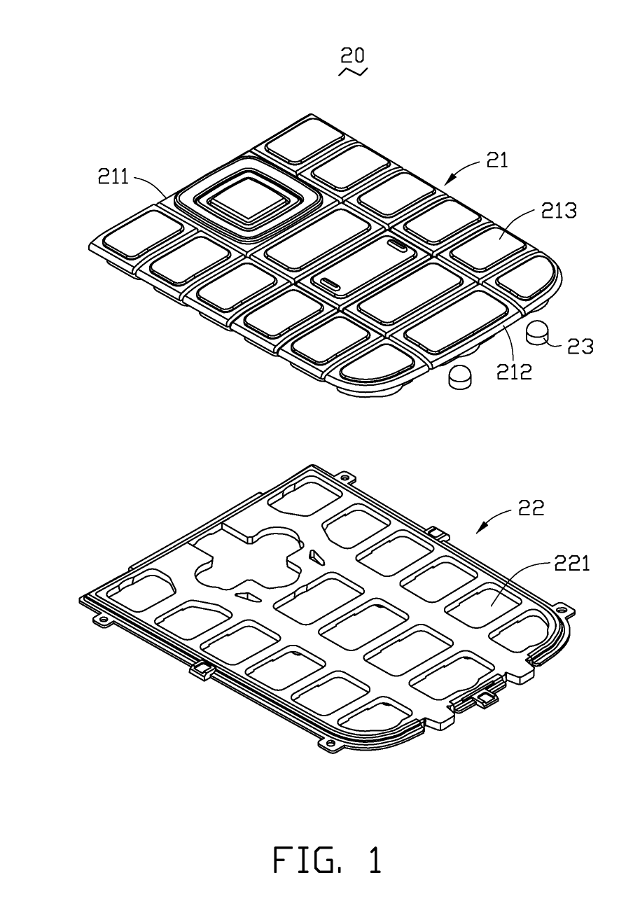

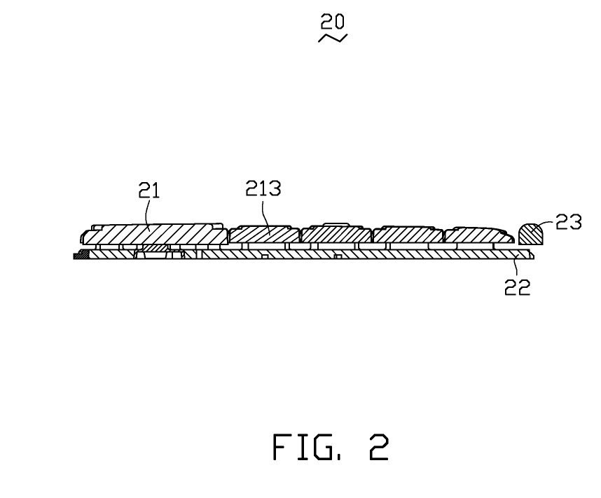

FIGS. 1 and 2 show an exemplary embodiment of a keypad assembly 20 used in a portable electronic device (e.g., mobile phone). The keypad assembly 20 includes a keypad 21, a shelf 22, and two light-emitting sources 23. The keypad 21 is mounted to the shelf 22. The light-emitting sources 23 are adjacent to the keypad 21.

The keypad 21 is made of a light-guiding material and includes a first end 211 and a second end 212. The keypad 21 forms a plurality of buttons 213.

The shelf 22 is generally planar, with button receiving cavities 221 defined therein. Each cavity 221 is configured to receive one button 213. The buttons 213 can be depressed into the cavities 221 to contact signal-sensing portions of a printed circuit board (not shown).

Each light-emitting source 23 is a light-emitting diode (LED). The LEDs are electrically mounted to the printed circuit board adjacent to the second end 212 of the keypad 21.

In use, most of the light emitted from the light-emitting sources 23 penetrates into the light-guiding material of keypad 21. Due to the light-guiding ability of the keypad 21, the light is then transmitted to each button 213 and illuminates the whole keypad assembly 20, thus eliminating the need for a separate light-guiding board. Therefore, the keypad assembly 20 is less complex and thus simpler to manufacture.

It is to be understood, however, that even through numerous characteristics and advantages of the present disclosed have been set forth in the foregoing description, together with details of the structure and function of the keypad assemble, the disclosure is illustrative only, and changes may be made in detail, especially in matters of shape, size, and arrangement of members within the principles of the invention to the full extent indicated by the broad general meaning of the terms, in which the appended claims are expressed.

What is claimed is:

1. A keypad assembly, comprising:
a shelf;
a keypad made of a light-guiding material, the keypad being mounted to the shelf; and
at least one light-emitting source facing the keypad and being adjacent to the keypad.

2. The keypad assembly as claimed in claim 1, wherein the keypad defines a plurality of buttons.

3. The keypad assembly as claimed in claim 2, wherein the shelf defines a plurality of button receiving cavities, each button being moveably received in a corresponding button receiving cavity.

4. The keypad assembly as claimed in claim 1, wherein the light-emitting source is a light-emitting diode.

5. A portable electronic device, comprising:
a shelf;
a keypad made of a light-guiding material, the keypad being mounted to the shelf; and
at least one light-emitting source facing the keypad, the light-emitting source being adjacent to the keypad.

6. The portable electronic device as claimed in claim 5, wherein the keypad defines a plurality of buttons.

7. The portable electronic device as claimed in claim 6, wherein the shelf defines a plurality of button receiving cavities, each button being moveably received in a corresponding button receiving cavity.

8. The portable electronic device as claimed in claim 5, wherein the light-emitting source is a light-emitting diode.
